(19) United States
(12) Patent Application Publication
(10) Pub. No.: US 2021/0360609 A1
(43) Pub. Date: Nov. 18, 2021

(54) UTILIZATION OF PHYSICAL RESOURCE BLOCKS IN A SIDELINK RESOURCE POOL

(71) Applicant: QUALCOMM Incorporated, San Diego, CA (US)

(72) Inventors: Gabi Sarkis, San Diego, CA (US); Wanshi Chen, San Diego, CA (US); Peter Gaal, San Diego, CA (US); Shailesh Patil, San Diego, CA (US); Tien Viet Nguyen, Bridgewater, NJ (US); Gideon Shlomo Kutz, Ramat Hasharon (IL)

(21) Appl. No.: 17/243,193

(22) Filed: Apr. 28, 2021

Related U.S. Application Data
(60) Provisional application No. 63/025,864, filed on May 15, 2020.

(51) Int. Cl. H04W 72/04; H04L 5/00

(52) U.S. Cl. CPC H04W 72/048; H04L 5/0048; H04W 72/0406

(57) ABSTRACT

A method or apparatus for wireless communication at a wireless device. The wireless device transmits or receives an indication of support for using a set of remaining physical resource blocks (PRBs) in a resource pool including one or more sub-channels having an equal number of PRBs and the set of remaining PRBs that are not in the one or more sub-channels having the equal number of PRBs. The wireless device transmits or receives sidelink communication in the set of remaining PRBs.

### CROSS-REFERENCE TO RELATED APPLICATION(S)

This application claims the benefit of U.S. Provisional Application Ser. No. 63/025,864, entitled “Utilization of Physical Resource Blocks in a Sidelink Resource Pool” and filed on May 15, 2020, which is expressly incorporated by reference herein in its entirety.

### BACKGROUND

### Technical Field

The present disclosure relates generally to communication systems, and more particularly to sidelink communication, such as vehicle-to-everything (V2X) or other device-to-device (D2D) communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. The apparatus determines a resource pool having a plurality of physical resource blocks (PRBs) including a first set of PRBs that comprises one or more sub-channels having an equal number of PRBs and a second set of PRBs that are not in the one or more sub-channels having the equal number of PRBs. The apparatus transmits or receives sidelink communication in the second set of PRBs based on a cast type of the sidelink communication or based on UE capability exchange.

In an aspect of the disclosure, a method, a computer-readable medium, and an apparatus are provided for wireless communication. The transmits or receives an indication of support for using a set of remaining physical resource blocks (PRBs) in a resource pool including one or more sub-channels having an equal number of PRBs and the set of remaining PRBs that are not in the one or more sub-channels having the equal number of PRBs. The wireless device transmits or receives sidelink communication in the set of remaining PRBs.

To the accomplishment of the foregoing and related ends, the one or more aspects comprise the features hereinafter fully described and particularly pointed out in the claims. The following description and the annexed drawings set forth illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network including a user equipment (UE) having a sidelink resource component in accordance with aspects presented herein.

FIG. 2 illustrates example aspects of a sidelink slot structure.

FIG. 3 is a diagram illustrating an example of a first device and a second device involved in wireless communication based, e.g., on sidelink.

FIG. 4 illustrates an example of communication between wireless devices based on sidelink including a sidelink resource component in accordance with aspects presented herein.

FIG. 5 illustrates an example of resource reservation in sidelink.

FIG. 6 illustrates examples of resource pools for sidelink communication including remaining PRBs in accordance with aspects presented herein.

FIG. 7 illustrates examples of resource pools for sidelink communication including remaining PRBs in accordance with aspects presented herein.

FIG. 8 illustrates example aspects of resources for sidelink communication including remaining PRBs in accordance with aspects presented herein.

FIG. 9 illustrates example aspects of resources for sidelink communication including remaining PRBs in accordance with aspects presented herein.

FIG. 10 illustrates an example communication flow between two UEs including an exchange of capability information for support to use of remaining PRBs in a resource pool in accordance with aspects presented herein.

FIG. 11 is a flowchart of a method of wireless communication including the use of remaining PRBs in a resource pool in accordance with aspects presented herein.

FIG. 12 is a flowchart of a method of wireless communication including the use of remaining PRBs in a resource pool in accordance with aspects presented herein.

FIG. 13 is a diagram illustrating an example of a hardware implementation for an example apparatus configured to use remaining PRBs in a resource pool in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

Sidelink communication, such as V2X, may be exchanged using a non-centralized allocation scheme in which a base station does not allocate the resources or using a centralized scheme in which a base station allocates the resource. A resource pool for the communication may include a bandwidth that spans a number of PRBs. The bandwidth may be separated into sub-channels having a defined size. The size of the resource pool, e.g., the total number of PRBs in the resource pool, and the number of PRBs in a sub-channel may be configured. The total number of PRBs of the resource pool may be separated into sub-channels having equal numbers of PRBs according to the configuration. However, the total number of PRBs may not be a multiple of a sub-channel size. The PRBs that are grouped into the equal sized sub-channels may include a first set of PRBs from the resource pool, and the remaining PRBs may form a second set of PRBs from the resource pool. The term remaining PRBs may refer to the PRBs that are not grouped into the equal sized sub-channels due to the number of PRBs not being a multiple of the configured size of the sub-channels. The remaining PRBs could be grouped into one or more sub-channels smaller than the defined size, included in other sub-channels to form sub-channels larger than the defined size, or not grouped or included in a sub-channel. Aspects presented herein enable a more efficient use of the PRBs of a sidelink resource pool by enabling the remaining PRBs, which are not grouped into a sub-channel of the defined size according to the configured sub-channel size, to be used for sidelink communication.

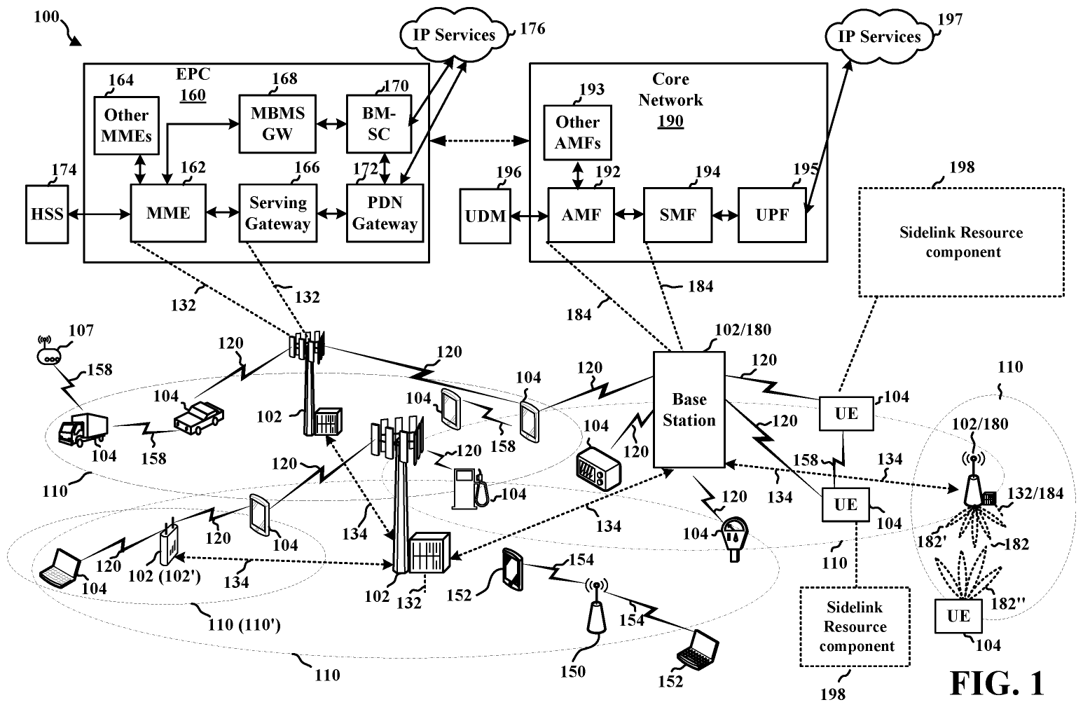

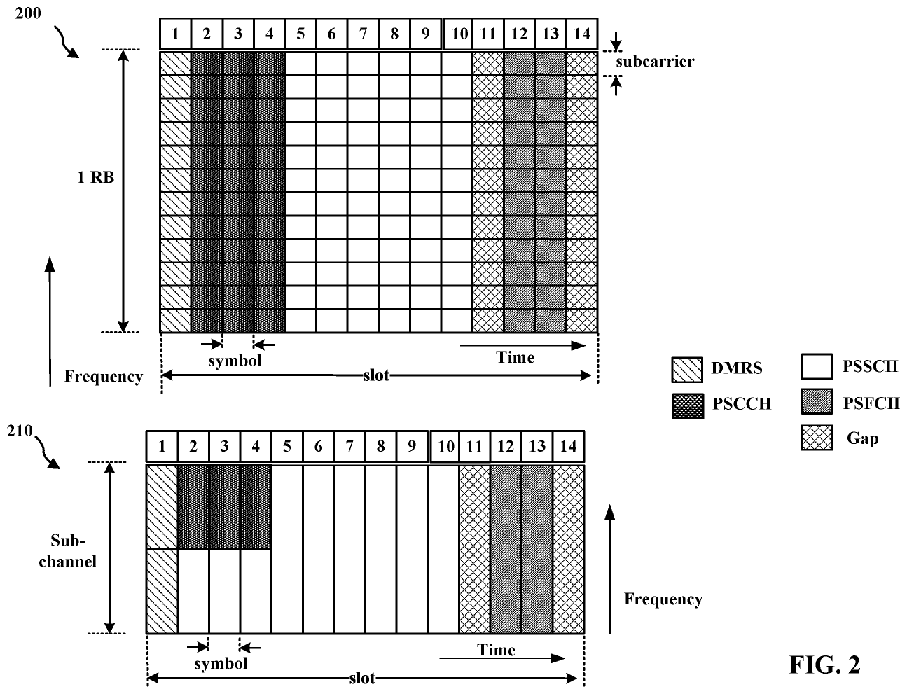

FIG. 1 is a diagram illustrating an example of a wireless communications system and an access network 100. Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Referring again to FIG. 1, in some aspects, a UE 104, e.g., a transmitting Vehicle User Equipment (VUE) or other UE, may be configured to transmit messages directly to another UE 104. The communication may be based on V2X or other D2D communication, such as Proximity Services (ProSe), etc. Communication based on V2X and/or D2D may also be transmitted and received by other transmitting and receiving devices, such as Road Side Unit (RSU) 107, etc. Aspects of the communication may be based on PC5 or sidelink communication e.g., as described in connection with the example in FIG. 2. Although the following description may provide examples for V2X/D2D communication in connection with 5G NR, the concepts described herein may be applicable to other similar areas, such as LTE, LTE-A, CDMA, GSM, and other wireless technologies.

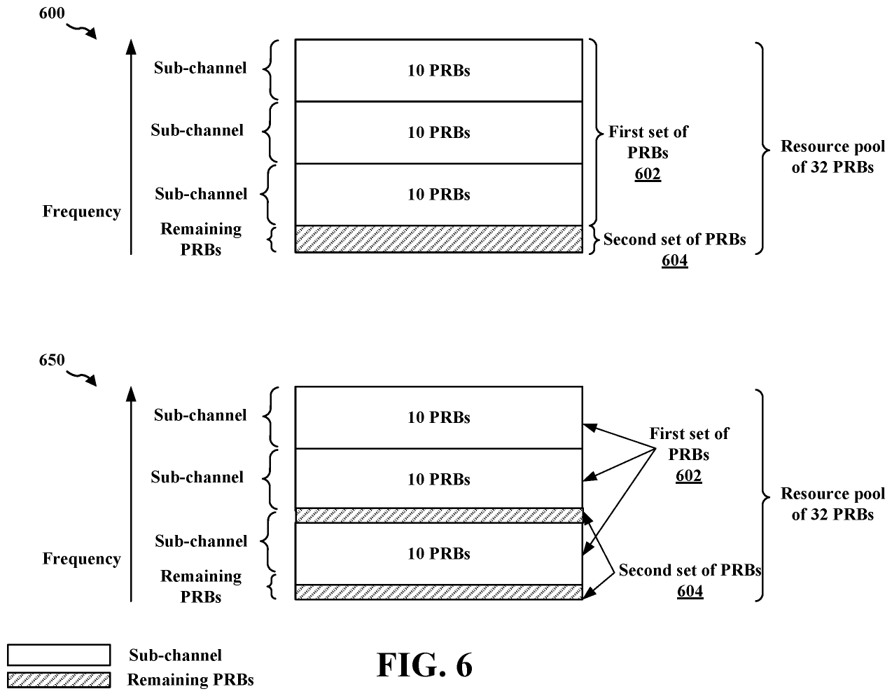

In some examples, the UE 104 may communicate using a sidelink resource pool having a plurality of PRBs including a first set of PRBs that comprises one or more sub-channels having an equal number of PRBs and a second set of PRBs that are not in the one or more sub-channels having the equal number of PRBs, such as described in connection with FIG. 6. The UE 104 may include a sidelink resource component 198 configured to transmit or receive sidelink communication in the second set of PRBs based on a cast type of the sidelink communication.

The wireless communications system (also referred to as a wireless wide area network

(WWAN)) includes base stations 102, UEs 104, an Evolved Packet Core (EPC) 160, and a Core Network (e.g., 5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for NR (collectively referred to as Next Generation RAN (NG-RAN)) may interface with Core Network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or Core Network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range.

Devices may use beamforming to transmit and receive communication. For example, FIG. 1 illustrates that a base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The Core Network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the Core Network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or Core Network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information in PSCCH and some Res may comprise demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

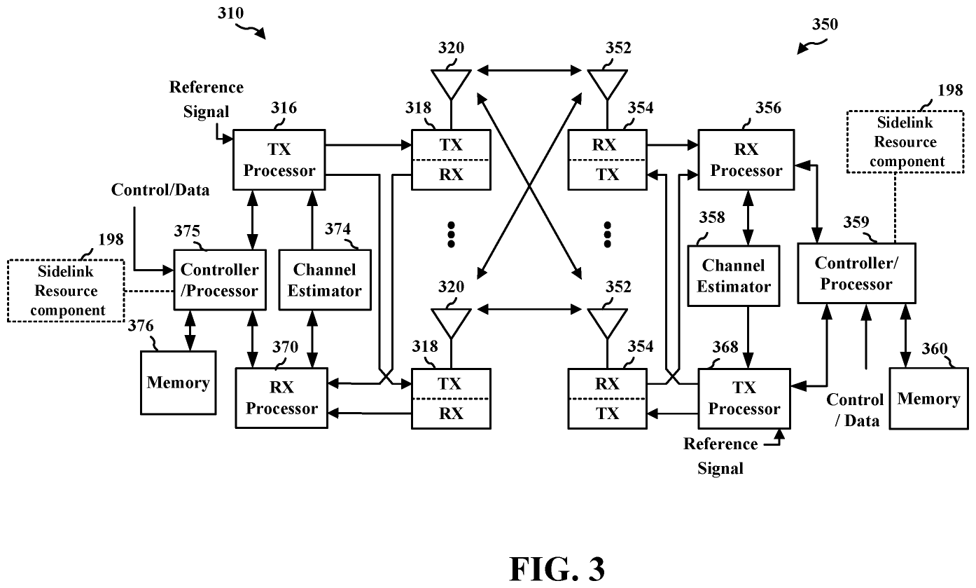

FIG. 3 is a block diagram of a first wireless communication device 310 in communication with a second wireless communication device 350. In some examples, the devices 310 and 350 may communicate based on sidelink, which may include V2X or other D2D communication. The communication may be based, e.g., on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, or the controller/processor 359 of device 350 or the TX 316, the RX processor 370, or the controller/processor 375 may be configured to perform aspects described in connection with the sidelink resource component 198 of FIG. 1.

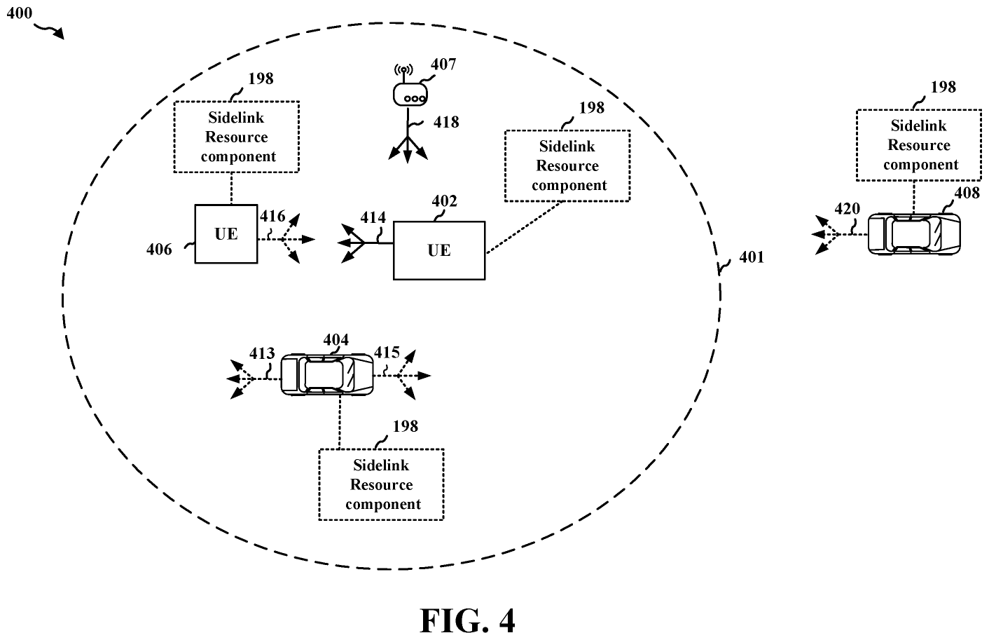

FIG. 4 illustrates an example 400 of sidelink communication between devices. The communication may be based on a slot structure comprising aspects described in connection with FIG. 2. For example, the UE 402 may transmit a sidelink transmission 414, e.g., comprising a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit communication 413, 415 intended for receipt by other UEs within a range 401 of UE 404, and UE 406 may transmit communication 416. Additionally/alternatively, RSU 407 may receive communication from and/or transmit communication 418 to UEs 402, 404, 406, 408. One or more of the UEs 402, 404, 406, 408 or the RSU 407 may comprise a sidelink resource component 198 as described in connection with FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

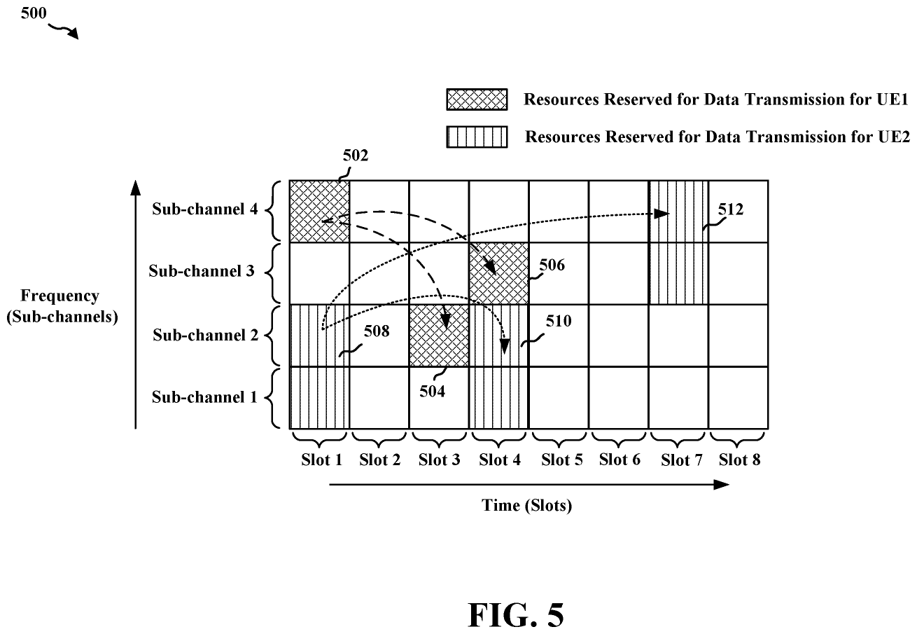

FIG. 5 is an example 500 of time and frequency resources showing reservations for sidelink transmissions. The resources may be comprised in a sidelink resource pool, for example. The resource allocation for each UE may be in units of one or more sub-channels in the frequency domain (e.g., sub-channels SC 1 to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., 504 and 506). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may do by including the reservation information in the reservation resource field of the SCI, e.g., a first stage SCI.

FIG. 5 illustrates that a second UE (“UE2”) reserves resources in sub-channels SC 3 and SC 4 at time slot 1 for its current data transmission 508, and reserve first data retransmission 510 at time slot 4 using sub-channels SC 3 and SC 4, and reserve second data retransmission 512 at time slot 7 using sub-channels SC 1 and SC 2 as shown by FIG. 5. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIS within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for different numbers of transmissions. For example, the reservation may be for more than two retransmissions. The reservation may be for an initial transmission and a single transmission. The reservation may be for an initial transmission. Each reservation of resources may have a priority level indicated in the SCI. A higher priority reservation may pre-empt a lower priority reservation.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, first, the UE may determine a set of candidate resources (e.g., by monitoring SCI from other UEs and removing resources from the set of candidate resources that are reserved by other UEs in a signal for which the UE measures an RSRP above a threshold value). Then, the UE may select N resources for transmissions and/or retransmissions of a TB. As an example, the UE may randomly select the N resources from the set of candidate resources determined in the first step. Then, for each transmission, the UE may reserve future time and frequency resources for an initial transmission and up to two retransmissions. The UE may reserve the resources by transmitting SCI indicating the resource reservation. For example, in the example in FIG. 5, the UE may transmit SCI reserving resources for data transmissions 508, 510, and 512.

As described in connection with FIG. 5, sidelink communication, such as V2X, may be exchanged using a non-centralized allocation scheme in which a base station does not allocate the resources or using a centralized allocation scheme in which a base station allocates the resources. A resource pool for the communication may include a bandwidth that spans a number of PRBs. The bandwidth may be separated into sub-channels having a defined size. The size of the resource pool, e.g., the total number of PRBs in the resource pool may be configured. A sub-channel size may also be configured. For example, a number of PRBs in a sub-channel may be configured per resource pool. Thus, the UE may receive a configuration of a resource pool spanning a number of PRBs, the bandwidth separated into sub-channels.

As illustrated in the example in FIG. 6, the total number of PRBs of the resource pool 600 may be separated into sub-channels having equal numbers of PRBs according to the configuration. However, the total number of PRBs may not be a multiple of a sub-channel size. For example, in FIG. 6, the bandwidth of the resource pool is 32 PRBs. The resource pool may be configured to have a sub-channel size of 10 PRBs. Thus, three sub-channels having 10 PRBs are provided, and there are 2 remaining PRBs. The PRBs that are grouped into the equal sized sub-channels may include a first set of PRBs 602 from the resource pool, and the remaining PRBs may form a second set of PRBs 604 from the resource pool. The term remaining PRBs may refer to the PRBs that are not grouped into the sub-channels of equal size due to the number of PRBs not being a multiple of the configured size of the sub-channels. For example the 3 remaining PRBs in FIG. 6 are due to the number of 32 PRBs not being a multiple of the 10 PRB size of the sub-channels.

The specific example of 32 PRBs and a sub-channel size of 10 illustrated in FIG. 6 is merely used to illustrate the concept. The concepts presented herein may be applied to a resource pool including any number of PRBs and to any size of sub-channels.

Additionally, the position of the remaining PRBs in FIG. 6 is merely to illustrate the concept of the remaining PRBs. The remaining PRBs, e.g., the second set of PRBs 604, may be located at a bandwidth edge of the resource pool, such as shown in the example resource pool 600, and/or between sub-channels, such as shown in the example resource pool 650 in FIG. 6. The second set of PRBs may be a consecutive group of PRBs, as in the example resource pool 600, or may be spaced apart, such as in the example resource pool 650.

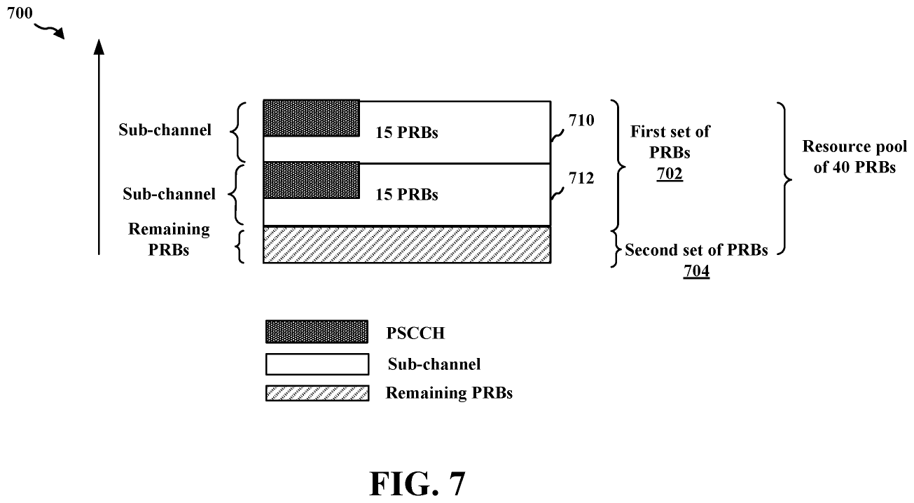

FIG. 7 illustrates an example sidelink resource pool 700 that spans 40 PRBs and has a configured sub-channel size of 15 PRBs. The first set of PRBs 702 is separated into two sub-channels each having 15 PRBs. The second set of PRBs 704 includes the 10 remaining PRBs after the sub-channels are determined. FIG. 7 illustrates that PSCCH may be transmitted in the PRBs of the sub-channels. As illustrated in the example in FIG. 7, the PSCCH may span a subset of the PRBs of the sub-channel. For example, in FIG. 7, the PSCCH may be transmitted on 10 of the 15 PRBs of a sub-channel. The specific example of 40 PRBs and a sub-channel size of 15 in FIG. 7 is merely to illustrate the concept. The concepts presented herein may be applied to a resource pool including any number of PRBs, to any size of sub-channels, and to any bandwidth for the PSCCH.

The remaining PRBs in a resource pool, e.g., the second set of PRBs 604 or 704, may be used in any of a number of ways. In a first example, the remaining PRBs may be used as an additional part of an adjacent sub-channel. In another example, the remaining PRBs may be distributed among different sub-channels in a resource pool. In another example, the PRBs may be used as an independent sub-channel.

Sidelink communication, such as described in connection with FIG. 4, may be exchanged in different ways. In a first example, the sidelink communication may include broadcast sidelink communication that is transmitted by a UE and may be received by any UE within range of the transmitting UE. In another example, the sidelink communication may include groupcast sidelink communication that is transmitted by a UE to a group of UEs. The group of UEs may be referred to as a service group. The communication may be received by UEs within range of the transmitting UE and that are a member of the group. For example, UEs that are members of the group may receive or know information that enables them to decode the groupcast messages. In another example, the sidelink communication may include unicast transmissions that are exchanged directly between a transmitting UE and a receiving UE as the intended recipient of the unicast transmission. The different types of sidelink transmissions, e.g., broadcast, groupcast, and unicast, may be referred to as “cast types” for the sidelink communication.

As presented herein, the remaining PRBs (e.g., 604/704) may be used by a transmitting UE based on a cast type of the sidelink communication. For example, the transmitting UE may transmit sidelink data, control, and/or feedback using the remaining PRBs if the sidelink transmission will be transmitted using a particular cast type. In one example, the transmitting UE may use the remaining PRBs (e.g., 604/704) if the transmission is a unicast sidelink transmission. For example, unicast transmissions may support the exchange of UE capability information between the transmitting UE and the receiving UE. For example, the sidelink UEs may exchange information as part of a PC5-RRC configuration exchange. The exchange of UE capability information enables the transmitting UE to be aware of the receiving UE's capability to receive data, control, or feedback in the remaining PRBs and enables the receiving UE to be aware of whether the transmitting UE may transmit data, control, or feedback in the remaining PRBs.

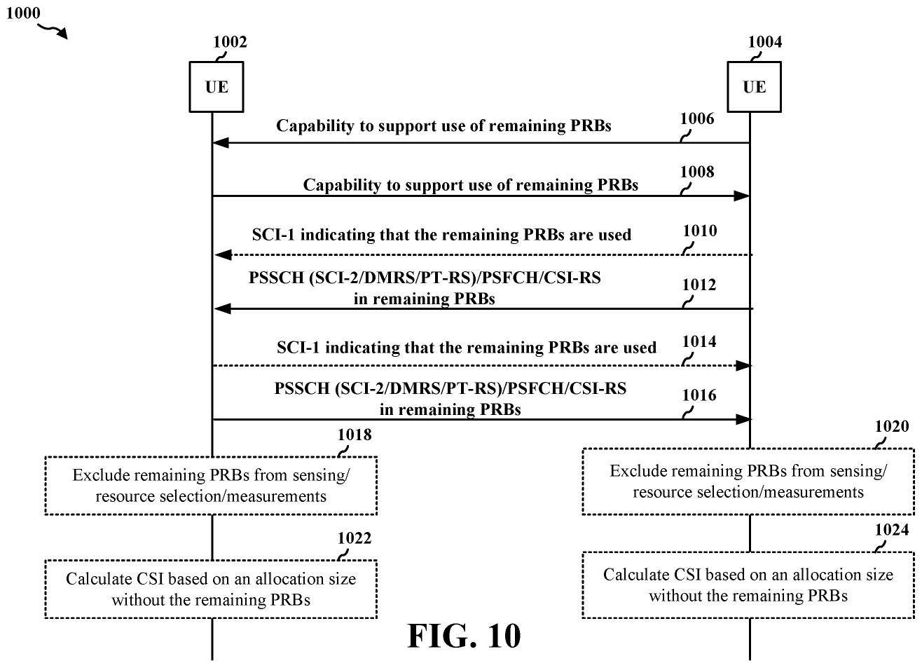

FIG. 10 illustrates an example communication flow 1000 between a first UE 1002 and a second UE 1004. As illustrated at 1006, the UE 1002 may receive UE capability information 1006 over sidelink indicating that the UE 1004 supports the use of the remaining PRBs in a sidelink resource pool. Similarly, the UE 1002 may transmit UE capability information 1008 indicating that the UE 1002 supports use of the remaining PRBs in a sidelink resource pool.

While this example is described for unicast, the aspects presented herein may be applied to other cast types that may be extended to include the exchange of capability information between the UEs.

In some examples, the use of the remaining PRBs may be further based on, or subject to, UE capability signaling. In some examples, the capability signaling 1006 or 1008 may indicate general support for using the remaining PRBs. In some examples, the capability signaling 1006 or 1008 may be specific to a particular number of remaining PRBs. A UE may signal capability, at 1006 or 1008, for multiple possible number of remaining PRBs. For example, the UE may send a first capability indication that indicates whether the UE is capable of using one remaining PRB, a second capability indication that indicates whether the UE is capable of using two remaining PRBs, a third capability indication that indicates whether the UE is capable of using three remaining PRBs, and so forth. Thus, while FIG. 10 illustrates a single capability 1006, the UE 1002 and/or 1004 may indicate multiple capabilities, which may be transmitted in a single message or in individual messages.

As illustrated at 1012, the UE 1002 may receive a sidelink transmission that uses the remaining PRBs. As illustrated at 1016, the UE 1002 may transmit a sidelink transmission that uses the remaining PRBs.

In some examples, the remaining PRBs may be used when the adjacent sub-channel is used. For example, in FIG. 7, the UE 1002 or 1004 may use the remaining PRBs in the second set of PRBs 704 if the UE transmits on the sub-channel 712. If the UE 1002 or 1004 transmits on the sub-channel 710 but not the sub-channel 712, the UE may determine not to use the remaining PRBs. In some examples, PSCCH may be mapped within PRBs belonging to the adjacent sub-channel, which may be referred to as a full sub-channel. A full sub-channel may refer to a sub-channel having the configured number of PRBs for the resource pool. In the example in FIG. 7, a full sub-channel is a sub-channel having 15 PRBs.

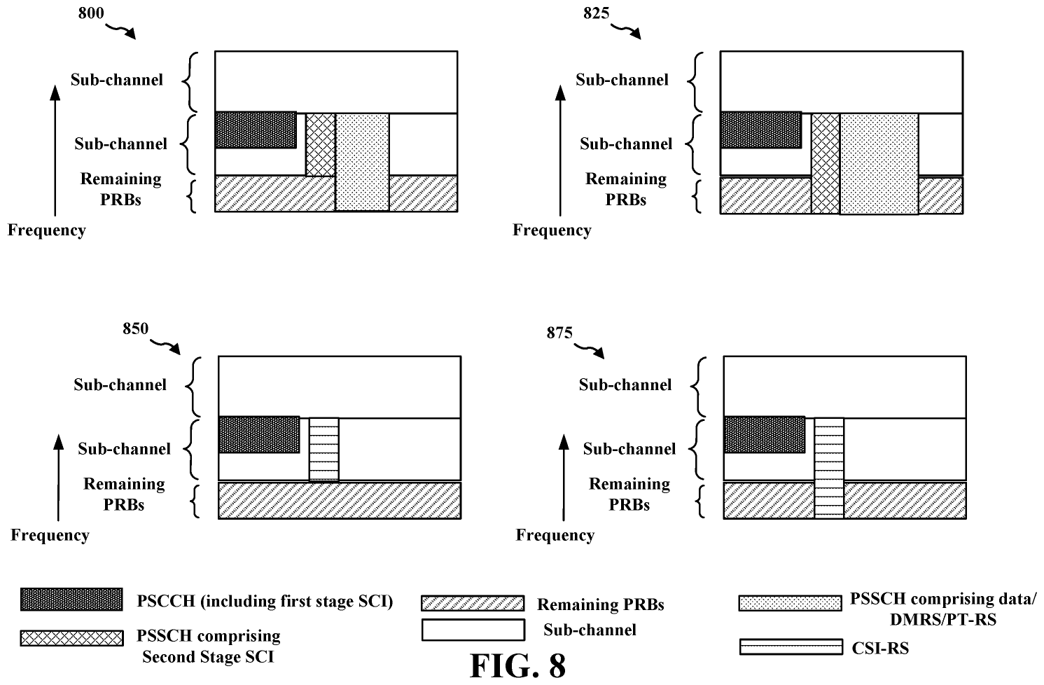

The SCI may be transmitted in two stages. A first portion of SCI, or a first stage of SCI (e.g., which may be referred to as SCI-1) may be transmitted in the PSCCH, which may be transmitted within a full sub-channel, as illustrated in FIG. 7. The second portion of the SCI (e.g., which may be referred to as SCI-2), or the second stage of the SCI, may be transmitted in a PSSCH. As illustrated in the example 800 in FIG. 8, the second stage SCI that is comprised in PSSCH may be mapped within the PRBs of a full sub-channel. In another example, as illustrated in the example 825 in FIG. 8, the second stage SCI that is comprised in PSSCH may be mapped to PRBs in a full sub-channel and the remaining PRBs, e.g., if the sub-channel is adjacent to the remaining PRBs, as illustrated in FIG. 8. Other PSSCH, such as data, DMRS, PT-RS, etc. may be mapped to both PRBs belonging to the adjacent sub-channel and the remaining PRBs, such as shown in the examples 800 and 850 in FIG. 8. Thus, the sidelink transmission 1012 or 1016 may include PSSCH including one or more of data, SCI-2, DMRS, and/or PT-RS mapped to at least some of the remaining PRBs.

In some examples, second stage SCI that is mapped to the remaining PRBs, at 1012 or 1016, may not be decodable by a UE that does not support using the remaining PRBs or that is not aware that the remaining PRBs are being used. In some examples, the first stage SCI 1010 or 1014 may indicate that the additional PRBs are being used to transmit the second stage SCI. The receiving UE may use the indication in the first stage SCI 1010 or 1014 to receive the second stage SCI in the remaining PRBs. The indication may be an explicit indication that the second stage SCI is mapped to the remaining PRBs. In another example, the indication may be an implicit indication from which the receiving UE may determine that the second stage SCI is mapped to the remaining PRBs. As another example, the receiving UE may attempt to decode the second stage SCI twice, e.g., a first time without the remaining PRBs and a second time with the remaining PRBs.

Example 850 in FIG. 8 illustrates an example in which CSI-RS may be mapped within a full sub-channel without extending into the remaining PRBs. Example 875 illustrates and example in which the CSI-RS may be mapped to both the PRBs of a full sub-channel and at least some of the remaining PRBs that are adjacent the sub-channel. Thus, the sidelink transmission 1012 or 1016 may include CSI-RS mapped to at least some of the remaining PRBs.

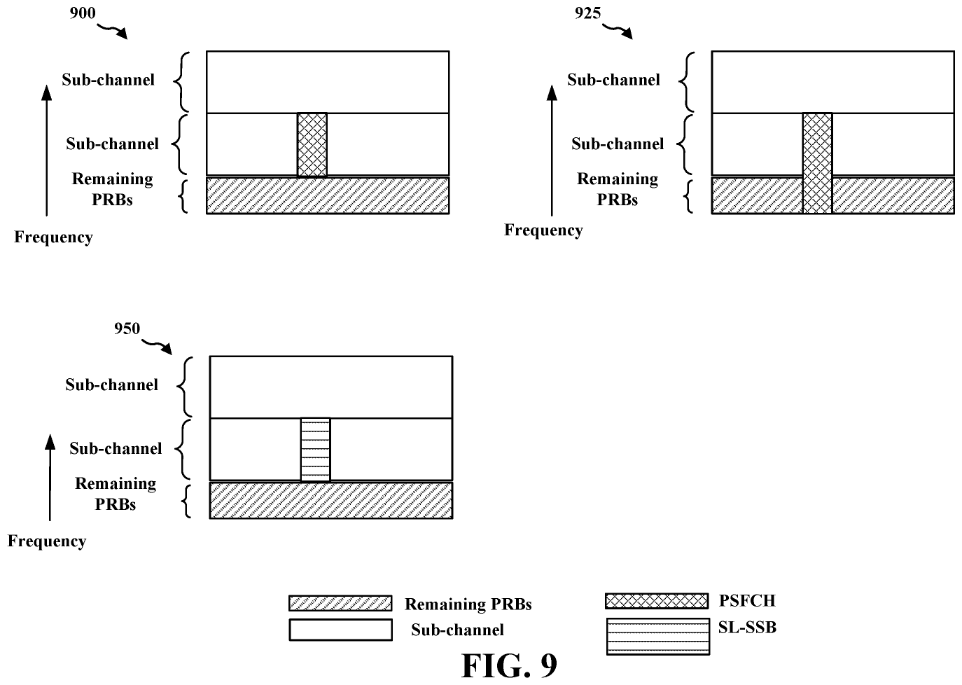

Example 900 in FIG. 9 illustrates an example in which a physical sidelink feedback channel (PSFCH) may be mapped within a full sub-channel without extending into the remaining PRBs. Example 925 illustrates and example in which the PSFCH may be mapped to both the PRBs of a full sub-channel and at least some of the remaining PRBs that are adjacent the sub-channel. Thus, the sidelink transmission 1012 or 1016 may include PSFCH mapped to at least some of the remaining PRBs.

Example 950 in FIG. 9 illustrates an example in which a sidelink synchronization signal block (SL-SSB or SSB) may be mapped within a full sub-channel without extending into the remaining PRBs.

In some examples, the UE may exclude the remaining PRBs (e.g., 604/704) when performing procedures such as sensing for resource selection and/or performing measurements, e.g., as illustrated at 1018 and/or 1020. As a first example, the UE may determine not to use the remaining PRBs to sense for resource reservations from other UEs. For example, the UE may refrain from decoding first stage SCI (e.g., SCI-1) in the remaining PRBs. The UE may refrain from performing reference signal receive power (RSRP) measurements on the remaining PRBs. The remaining PRBs may be excluded from other measurements, such as received signal strength indicator (RSSI), etc. In some examples, if the remaining PRBs are grouped into a sub-channel having a smaller size than the configured number of PRBs, the sub-channel may be excluded from sensing and resource selection procedures. In some examples, the reference resource for calculating channel state information (CSI) may correspond to an allocation size without the remaining PRBs, e.g., as illustrated at 1022 and/or 1024. For a given CSI trigger, the time location, or time domain, of the sidelink SCI reference resource may be in the slot where the CSI trigger is received. The frequency location, or frequency domain, of the CSI reference resource may be the PRBs scheduled for the PSSCH in a CSI reference resource slot without the remaining PRBs. The order of 1018, 1020, 1022, and 1024 may be different relative to 1006-1016 than the order shown in FIG. 10.

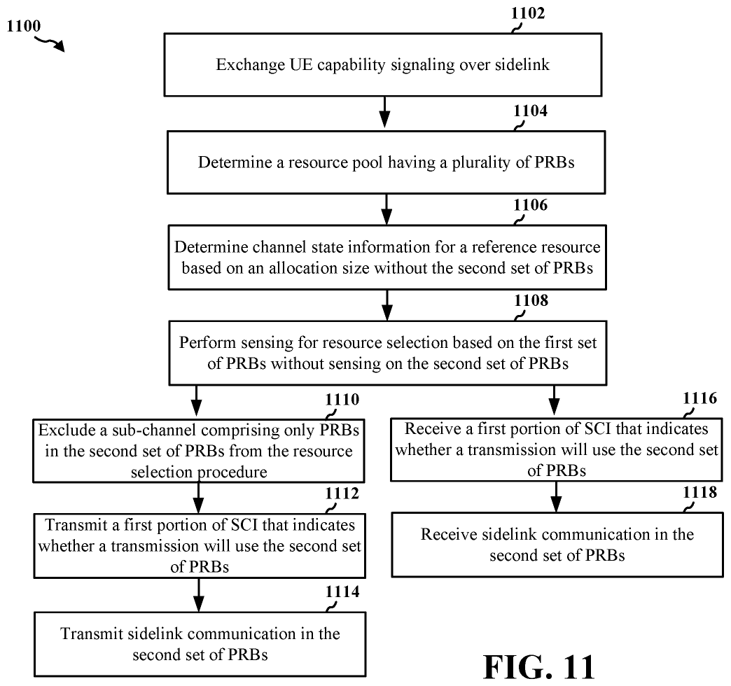

FIG. 11 is a flowchart 1100 of a method of wireless communication. The method may be performed by a wireless device communicating based on sidelink (e.g., a UE 104, an RSU 107, a device 310, 350; the apparatus 1302). Various implementations may include a method with any combination of the aspects described in connection with FIG. 11. The method may improve the efficient use of PRBs within a resource pool.

At 1104, the wireless device determines a resource pool having a plurality of PRBs including a first set of PRBs that comprises one or more sub-channels having an equal number of PRBs and a second set of PRBs that are not in the one or more sub-channels having the equal number of PRBs. The number of the plurality of PRBs in the resource pool may be configured. The number of PRBs in each sub-channel may be configured. FIGS. 6 and 7 illustrate examples of sidelink resource pools. The determination may be performed, e.g., by the resource pool component 1340.

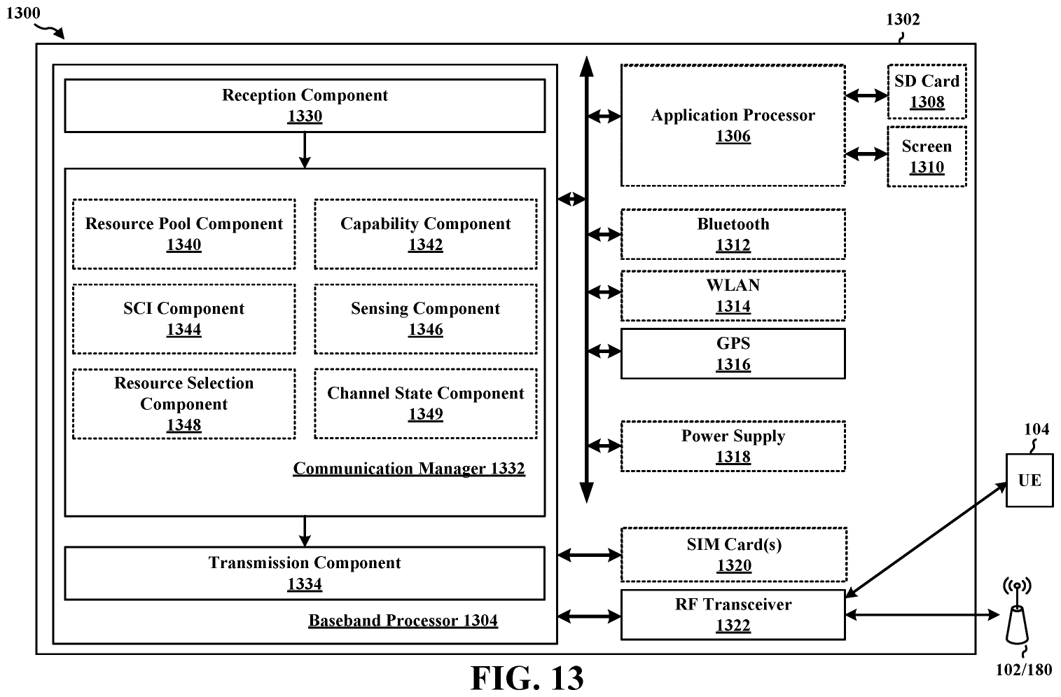

Then, the wireless device may transmit or receive sidelink communication in the second set of PRBs based on a cast type of the sidelink communication. Examples of cast types include broadcast, groupcast/multicast, or unicast. For example, if the sidelink communication is based on a particular cast type, the UE may transmit the sidelink communication in the second set of PRBs, at 1114. If the sidelink communication is based on a particular cast type, the UE may receive the sidelink communication in the second set of PRBs, at 1118. In some examples, the wireless device may transmit or receive the sidelink communication in the second set of PRBs if the cast type is unicast. The transmission or reception may be performed, e.g., by the transmission component 1334 or the reception component 1330 of the apparatus 1302 in FIG. 13.

In some aspects, the wireless device may transmit or receive the sidelink communication in the second set of PRBs, e.g., at 1114 or 1118, if the cast type supports a capability exchange. For example, unicast sidelink communication may support a UE capability exchange, and the wireless device may transmit or receive the sidelink communication as a unicast in the second set of PRBs.

Additionally, the wireless device may exchange UE capability information over sidelink, at 1102. The capability exchange may be performed, e.g., by the capability component 1342, the reception component 1330, and/or the transmission component 1334 of the apparatus 1302 in FIG. 13. Then, the wireless device may transmit or receive the sidelink communication in the second set of PRBs, at 1114 or 1118, based at least in part on exchanging the UE capability information. The UE capability information may indicate support for using the second set of PRBs. The UE capability information may indicate support for using the second set of PRBs in connection with a number of PRBs in the second set of PRBs. The UE capability information may include a plurality of indications of support for using the second set of PRBs for different numbers of PRBs in the second set of PRBs. For example, the UE may send a first capability indication that indicates whether the UE is capable of using one remaining PRB, a second capability indication that indicates whether the UE is capable of using two remaining PRBs, a third capability indication that indicates whether the UE is capable of using three remaining PRBs, and so forth.

The wireless device may transmit or receive the sidelink communication in the second set of PRBs, at 1114 or 1118, further based on using an adjacent sub-channel to the second set of PRBs. For example, the wireless device may use the remaining PRBs in a resource pool if the UE is transmitting/receiving in an adjacent sub-channel. If the UE is not transmitting/receiving in an adjacent sub-channel, the UE may not use the remaining PRBs.

The wireless device may transmit or receive a PSCCH comprising a first portion of sidelink control information (SCI) in the first set of PRBs and not in the second set of PRBs. For example, FIG. 8 illustrates various example aspects of transmission of PSCCH in the sub-channel(s) of a sidelink resource pool, e.g., the first set of PRBs.

The wireless device may transmit or receive at least a portion of a PSSCH in the second set of PRBs. For example, FIG. 8 illustrates various example aspects of transmission of PSSCH in the remaining PRBs of a sidelink resource pool. As described in connection with FIG. 8, the portion of the PSSCH that is transmitted or received in the second set of PRBs may comprise at least one of data, a demodulation reference signal, and a PT-RS. The portion of the PSSCH that includes a second portion of the SCI may be transmitted or received in the first set of PRBs and not in the second set of PRBs, such as described in connection with example 800 in FIG. 8. In other examples, the PSSCH may include a second portion of the SCI in the second set of PRBs and at least an adjacent sub-channel comprising PRBs from the first set of PRBs, such as described in connection with example 825 in FIG. 8.

The wireless device may transmit or receive a CSI-RS in the first set of PRBs and not in the second set of PRBs, such as described in connection with example 850 in FIG. 8. In other examples, the wireless device may transmit or receive at least a portion of a CSI-RS in the second set of PRBs and at least an adjacent sub-channel comprising PRBs from the first set of PRBs, such as described in connection with example 875 in FIG. 8.

The wireless device may transmit or receive a PSFCH in the first set of PRBs and not in the second set of PRBs, such as described in connection with example 900 in FIG. 9. In other examples, the wireless device may transmit or receive at least a portion of a PSFCH in the second set of PRBs and at least an adjacent sub-channel comprising PRBs from the first set of PRBs, such as described in connection with example 925 in FIG. 9.

The wireless device may transmit or receive a sidelink SSB in the first set of PRBs and not in the second set of PRBs, such as described in connection with example 950 in FIG. 9.

As illustrated at 1112, the wireless device may transmit a first portion of sidelink control information that indicates whether a transmission will use the second set of PRBs. The transmission may be performed, e.g., by the SCI component 1344 and/or the transmission component 1334 of the apparatus 1302 in FIG. 13. Then, the wireless device may transmit the sidelink communication, e.g., at 1114, based on the indication at 1112.

As illustrated at 1116, the wireless device may receive a first portion of sidelink control information that indicates whether a transmission will use the second set of PRBs. The reception may be performed, e.g., by the SCI component 1344 and/or the reception component 1330 of the apparatus 1302 in FIG. 13. Then, the wireless device may receive the sidelink communication, e.g., at 1118, based on the indication at 1116.

As illustrated at 1108, the wireless device may perform sensing for resource selection based on the first set of PRBs without sensing on the second set of PRBs. The exclusion and the sensing may be performed, e.g., by the sensing component 1346 and/or the reception component 1330 of the apparatus 1302 in FIG. 13. For example, the wireless device may not perform measurements, e.g., may refrain from performing measurements, on reference signals in the second set of PRBs.

As illustrated at 1110, the wireless device may exclude a sub-channel including the PRBs in the second set of PRBs and not the first set of PRBs from the resource selection procedure. As an example, the wireless device may exclude a sub-channel comprising only PRBs in the second set of PRBs from the resource selection procedure. The exclusion and the selection may be performed, e.g., by the resource selection component 1348 of the apparatus 1302 in FIG. 13. Thus, the wireless device may select the resources for the transmission that occurs at 1114 based on an exclusion of the smaller sized sub-channel from the resource selection.

As illustrated at 1106, the wireless device may determine channel state information for a reference resource based on an allocation size without the second set of PRBs. The channel state information determination may be performed, e.g., by the channel state component 1349 of the apparatus 1302 in FIG. 13.

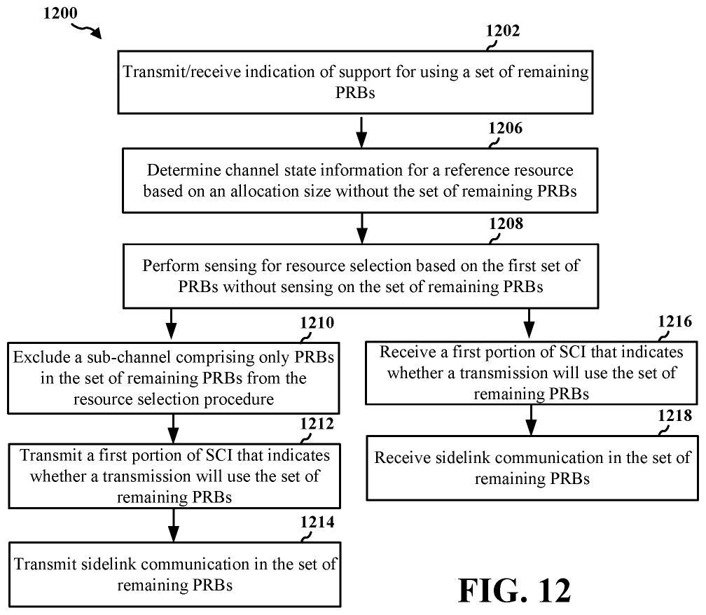

FIG. 12 is a flowchart 1200 of a method of wireless communication. The method may be performed by a wireless device communicating based on sidelink (e.g., a UE 104, 402, 1002, 1004, an RSU 107, a device 310, 350; the apparatus 1302). Various implementations may include a method with any combination of the aspects described in connection with FIG. 12. The method may improve the efficient use of PRBs within a resource pool.

At 1202, the wireless device transmits or receives an indication of support for using a set of remaining PRBs (e.g., the second set of PRBs as described in connection with FIG. 11) in a resource pool comprising one or more sub-channels having an equal number of PRBs (e.g., the first set of PRBs described in connection with FIG. 11) and the set of remaining PRBs that are not in the one or more sub-channels having the equal number of PRBs. In some aspects, the indication may comprise capability information or may be comprised in capability information. The number of the plurality of PRBs in the resource pool may be configured. The number of PRBs in each sub-channel may be configured. FIGS. 6 and 7 illustrate examples of sidelink resource pools. FIG. 10 illustrates example aspects of transmitting/receiving capability information 1006 or 1008. For example, the wireless device may exchange UE capability information over sidelink. The capability exchange may be performed, e.g., by the capability component 1342, the reception component 1330, and/or the transmission component 1334 of the apparatus 1302 in FIG. 13. The UE capability information may indicate support for using the set of remaining PRBs. The UE capability information may indicate support for using the set of remaining PRBs in connection with a number of PRBs in the set of remaining PRBs. The UE capability information may include a plurality of indications of support for using the set of remaining PRBs for different numbers of PRBs in the set of remaining PRBs. For example, the UE may send a first capability indication that indicates whether the UE is capable of using one remaining PRB, a second capability indication that indicates whether the UE is capable of using two remaining PRBs, a third capability indication that indicates whether the UE is capable of using three remaining PRBs, and so forth.

At 1214 and/or 1218, the wireless device may transmit or receive sidelink communication in the set of remaining PRBs. FIG. 10 illustrates example aspects of transmitting/receiving sidelink transmissions, at 1012 and 1016, following the exchange of capability information indicating support for use of the remaining PRBs. The wireless device may transmit or receive the sidelink communication in the set of remaining PRBs, at 1214 or 1218, based at least in part on the capability information indicating support for the use of the remaining PRBs. In some aspects, the wireless device may transmit or receive the sidelink communication in the set of remaining PRBs based on a cast type of the sidelink communication. Examples of cast types include broadcast, groupcast/multicast, or unicast. For example, if the sidelink communication is based on a particular cast type, the UE may transmit the sidelink communication in the set of remaining PRBs, at 1214. If the sidelink communication is based on a particular cast type, the UE may receive the sidelink communication in the set of remaining PRBs, at 1218. In some examples, the wireless device may transmit or receive the sidelink communication in the set of remaining PRBs based on the sidelink transmission being unicast or being a cast type that supports the exchange of capability information. The transmission or reception may be performed, e.g., by the transmission component 1334 or the reception component 1330 of the apparatus 1302 in FIG. 13.

In some aspects, the wireless device may transmit or receive the sidelink communication in the set of remaining PRBs, e.g., at 1214 or 1218, if the cast type supports a capability exchange. For example, unicast sidelink communication may support a UE capability exchange, and the wireless device may transmit or receive the sidelink communication as a unicast in the set of remaining PRBs.

The wireless device may transmit or receive the sidelink communication in set of remaining PRBs, at 1214 or 1218, further based on using an adjacent sub-channel to set of remaining PRBs. For example, the wireless device may use the remaining PRBs in a resource pool if the UE is transmitting/receiving in an adjacent sub-channel. If the UE is not transmitting/receiving in an adjacent sub-channel, the UE may not use the remaining PRBs.

The wireless device may transmit or receive a PSCCH comprising a first portion of SCI in the one or more sub-channels having an equal number of PRBs and not in the set of remaining PRBs. For example, FIG. 8 illustrates various example aspects of transmission of PSCCH in the sub-channel(s) of a sidelink resource pool, e.g., the one or more sub-channels having an equal number of PRBs.

The wireless device may transmit or receive at least a portion of a PSSCH in the set of remaining PRBs. For example, FIG. 8 illustrates various example aspects of transmission of PSSCH in the remaining PRBs of a sidelink resource pool. As described in connection with FIG. 8, the portion of the PSSCH that is transmitted or received in the set of remaining PRBs may comprise at least one of data, a demodulation reference signal, and a PT-RS. The portion of the PSSCH that includes a second portion of the SCI may be transmitted or received in the one or more sub-channels having an equal number of PRBs and not in the set of remaining PRBs, such as described in connection with example 800 in FIG. 8. In other examples, the PSSCH may include a second portion of the SCI in the set of remaining PRBs and at least an adjacent sub-channel comprising PRBs from the one or more sub-channels having an equal number of PRBs, such as described in connection with example 825 in FIG. 8.

The wireless device may transmit or receive a CSI-RS in the one or more sub-channels having an equal number of PRBs and not in the set of remaining PRBs, such as described in connection with example 850 in FIG. 8. In other examples, the wireless device may transmit or receive at least a portion of a CSI-RS in the set of remaining PRBs and at least an adjacent sub-channel comprising PRBs from the one or more sub-channels having an equal number of PRBs, such as described in connection with example 875 in FIG. 8.

The wireless device may transmit or receive a PSFCH in the one or more sub-channels having an equal number of PRBs and not in the set of remaining PRBs, such as described in connection with example 900 in FIG. 9. In other examples, the wireless device may transmit or receive at least a portion of a PSFCH in the set of remaining PRBs and at least an adjacent sub-channel comprising PRBs from the one or more sub-channels having an equal number of PRBs, such as described in connection with example 925 in FIG. 9.

The wireless device may transmit or receive a sidelink SSB in the one or more sub-channels having an equal number of PRBs and not in the set of remaining PRBs, such as described in connection with example 950 in FIG. 9.

As illustrated at 1212, the wireless device may transmit a first portion of sidelink control information that indicates whether a transmission will use the set of remaining PRBs. The transmission may be performed, e.g., by the SCI component 1344 and/or the transmission component 1334 of the apparatus 1302 in FIG. 13. Then, the wireless device may transmit the sidelink communication, e.g., at 1214, based on the indication at 1212.

As illustrated at 1216, the wireless device may receive a first portion of sidelink control information that indicates whether a transmission will use the set of remaining PRBs. The reception may be performed, e.g., by the SCI component 1344 and/or the reception component 1330 of the apparatus 1302 in FIG. 13. Then, the wireless device may receive the sidelink communication, e.g., at 1218, based on the indication at 1216.

As illustrated at 1208, the wireless device may perform sensing for resource selection based on the one or more sub-channels having an equal number of PRBs without sensing on the set of remaining PRBs. The exclusion and the sensing may be performed, e.g., by the sensing component 1346 and/or the reception component 1330 of the apparatus 1302 in FIG. 13. For example, the wireless device may not perform measurements, e.g., may refrain from performing measurements, on reference signals in the set of remaining PRBs.

As illustrated at 1210, the wireless device may exclude a sub-channel including the remaining set of PRBs and not having having the equal number of PRBs from the resource selection procedure. As an example, the wireless device may exclude a sub-channel comprising only PRBs in the set of remaining PRBs from the resource selection procedure. The exclusion and the selection may be performed, e.g., by the resource selection component 1348 of the apparatus 1302 in FIG. 13. Thus, the wireless device may select the resources for the transmission that occurs at 1214 based on an exclusion of the smaller sized sub-channel from the resource selection.

As illustrated at 1206, the wireless device may determine channel state information for a reference resource based on an allocation size without the set of remaining PRBs. The channel state information determination may be performed, e.g., by the channel state component 1349 of the apparatus 1302 in FIG. 13.

FIG. 13 is a diagram 1300 illustrating an example of a hardware implementation for an apparatus 1302. The apparatus 1302 is a wireless device that communications based on sidelink. In some aspects, the apparatus 1302 may be a UE or a component of a UE. The apparatus includes a baseband processor 1304 (also referred to as a modem) coupled to a RF transceiver 1322. In some aspects, the baseband processor 1304 may be a cellular baseband processor, and the RF transceiver may be a cellular RF transceiver. In some aspects, the apparatus 1302 may further include one or more of subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and/or a power supply 1318. The baseband processor 1304 communicates through the RF transceiver 1322 with the UE 104 and/or BS 102/180. The baseband processor 1304 may include a computer-readable medium / memory. The baseband processor 1304 is responsible for general processing, including the execution of software stored on the computer-readable medium / memory. The software, when executed by the baseband processor 1304, causes the baseband processor 1304 to perform the various functions described herein. The computer-readable medium/memory may also be used for storing data that is manipulated by the baseband processor 1304 when executing software. The baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband processor 1304. The baseband processor 1304 may be a component of the wireless device 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire device (e.g., see the device 310 or 350 of FIG. 3) and include the additional modules of the apparatus 1302.

The communication manager 1332 comprises a resource pool component 1340 for sidelink transmission on one or more resource pools including a first set of one or more sub-channels having an equal number of PRBs and a second set of remaining PRBs that are not in the one or more sub-channels having the equal number of PRBs. The communication manager 1332 further includes capability component 1342 configured to transmit or receive an indication of support for using a set of remaining PRBs in a resource pool comprising one or more sub-channels having an equal number of PRBs and the set of remaining PRBs that are not in the one or more sub-channels having the equal number of PRBs, e.g., as described in connection with 1102 and/or 1202. The apparatus 1302 further includes a transmission component 1334 configured to transmit sidelink communication in the set of remaining PRBs, e.g., as described in connection with 1114 and/or 1214. The apparatus 1302 further includes a reception component 1330 configured to receive sidelink communication in the set of remaining PRBs, e.g., as described in connection with 1118 and/or 1218.

The communication manager 1332 may further include an SCI component 1344 configured to transmit/receive a first portion of sidelink control information that indicates whether a transmission will use the set of remaining PRBs, e.g., as described in connection with any of 1112, 1212, 1116, or 1216. The communication manager 1332 may further include a sensing component 1346 performing sensing for resource selection based on the one or more sub-channels having an equal number of PRBs without sensing on the set of remaining PRBs, e.g., as described in connection with 1108 or 1208. The communication manager 1332 may further include a resource selection component 1348 configured to exclude a sub-channel comprising the PRBs in the set of remaining PRBs from a resource selection procedure (e.g., and not the PRBs from the first set of PRBs), e.g., as described in connection with 1110 or 1210. The communication manager 1332 may further include a channel state component 1349 configured to determine channel state information for a reference resource based on an allocation size without the set of remaining PRBs, e.g., as described in connection with 1002 or 1024.

The apparatus may include additional components that perform each of the blocks of the algorithm in the flowcharts of FIGS. 11 and/or 12, as well as the aspects of the communication flow in FIG. 10. As such, each block in the flowcharts of FIGS. 11 and/or 12, as well as the aspects of the communication flow in FIG. 10, may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband processor 1304, includes means for performing any of the aspects described in connection with the method in any of FIGS. 10-12. The apparatus 1302 includes means for transmitting or receiving capability information indicating support for using a set of remaining PRBs in a resource pool comprising one or more sub-channels having an equal number of PRBs and the set of remaining PRBs that are not in the one or more sub-channels having the equal number of PRBs; and means for transmitting or receiving sidelink communication in the set of remaining PRBs. The apparatus 1302 may further include means for transmitting a first portion of sidelink control information that indicates whether a transmission will use the set of remaining PRBs. The apparatus 1302 may further include means for receiving a first portion of sidelink control information that indicates whether a transmission will use the set of remaining PRBs. The apparatus 1302 may further include means for performing sensing for resource selection based on the one or more sub-channels having an equal number of PRBs without sensing on the set of remaining PRBs. The apparatus 1302 may further include means for excluding a sub-channel comprising PRBs in the set of remaining PRBs (e.g., and not the equal number of PRBs) from a resource selection procedure. The apparatus 1302 may further include means for determining channel state information for a reference resource based on an allocation size without the set of remaining PRBs. The means may be one or more of the components of the apparatus 1302 configured to perform the functions recited by the means. As described herein, the apparatus 1302 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other implementations or teachings described herein, without limitation.

Aspect 1 is a method of wireless communication at a wireless device, comprising: determining a resource pool having a plurality of PRBs including a first set of PRBs that comprises one or more sub-channels having an equal number of PRBs and a second set of PRBs that are not in the one or more sub-channels having the equal number of PRBs; and transmitting or receiving sidelink communication in the second set of PRBs based on a cast type of the sidelink communication.

In aspect 2, the method of aspect 1 further includes that the wireless device transmits or receives the sidelink communication in the second set of PRBs if the cast type is unicast.

In aspect 3, the method of aspect 1 or aspect 2 further includes that the wireless device transmits or receives the sidelink communication in the second set of PRBs if the cast type supports a capability exchange.

In aspect 4, the method of any of aspects 1-3 further includes exchanging user equipment (UE) capability information over sidelink, wherein the wireless device transmits or receives the sidelink communication in the second set of PRBs based at least in part on exchanging the UE capability information.

In aspect 5, the method of aspect 4 further includes that the UE capability information indicates support for using the second set of PRBs.

In aspect 6, the method of any of aspect 4 or aspect 5 further includes that the UE capability information indicates support for using the second set of PRBs in connection with a number of PRBs in the second set of PRBs.

In aspect 7, the method of aspect 6 further includes that the UE capability information includes a plurality of indications of support for using the second set of PRBs for different numbers of PRBs in the second set of PRBs.

In aspect 8, the method of any of aspects 1-7 further includes that wireless device transmits or receives the sidelink communication in the second set of PRBs further based on using an adjacent sub-channel to the second set of PRBs.

In aspect 9, the method of any of aspects 1-8 further includes that the wireless device transmits or receives a physical sidelink control channel (PSCCH) comprising a first portion of sidelink control information (SCI) in the first set of PRBs and not in the second set of PRBs.

In aspect 10, the method of any of aspects 1-9 further includes that the wireless device transmits or receives at least a portion of a physical sidelink shared channel (PSSCH) in the second set of PRBs.

In aspect 11, the method of aspect 10 further includes that the portion of the PSSCH that is transmitted or received in the second set of PRBs comprises at least one of data, a demodulation reference signal, and a phase tracking reference signal (PT-RS).

In aspect 12, the method of aspect 10 or aspect 11 further includes that the PSSCH includes a second portion of the SCI in the first set of PRBs and not in the second set of PRBs.

In aspect 13, the method of aspect 10 or aspect 11 further includes that the PSSCH includes a second portion of the SCI in the second set of PRBs and at least an adjacent sub-channel comprising PRBs from the first set of PRBs.

In aspect 14, the method of any of aspects 1-13 further includes that the wireless device transmits or receives a channel state information reference signal (CSI-RS) in the first set of PRBs and not in the second set of PRBs.

In aspect 15, the method of any of aspects 1-13 further includes that the wireless device transmits or receives at least a portion of a channel state information reference signal (CSI-RS) in the second set of PRBs and at least an adjacent sub-channel comprising PRBs from the first set of PRBs.

In aspect 16, the method of any of aspects 1-15 further includes that the wireless device transmits or receives a physical sidelink feedback channel (PSFCH) in the first set of PRBs and not in the second set of PRBs.

In aspect 17, the method of any of aspects 1-15 further includes that the wireless device transmits or receives at least a portion of a physical sidelink feedback channel (PSFCH) in the second set of PRBs and at least an adjacent sub-channel comprising PRBs from the first set of PRBs.

In aspect 18, the method of any of aspects 1-17 further includes that the wireless device transmits or receives a sidelink synchronization signal block (SSB) in the first set of PRBs and not in the second set of PRBs.

In aspect 19, the method of any of aspects 1-18 further includes transmitting a first portion of sidelink control information that indicates whether a transmission will use the second set of PRBs.

In aspect 20, the method of any of aspects 1-19 further includes receiving a first portion of sidelink control information that indicates whether a transmission will use the second set of PRBs.

In aspect 21, the method of any of aspects 1-20 further includes performing sensing for resource selection based on the first set of PRBs without sensing on the second set of PRBs.

In aspect 22, the method of any of aspects 1-21 further includes that the wireless device does not perform measurements on reference signals in the second set of PRBs.

In aspect 23, the method of any of aspects 1-22 further includes excluding a sub-channel comprising only PRBs in the second set of PRBs from a resource selection procedure.

In aspect 24, the method of any of aspects 1-23 further includes determining channel state information for a reference resource based on an allocation size without the second set of PRBs.

Aspect 25 is a method of wireless communication at a wireless device, comprising: transmitting or receiving an indication of support for using a set of remaining physical resource blocks (PRBs) in a resource pool comprising one or more sub-channels having an equal number of PRBs and the set of remaining PRBs that are not in the one or more sub-channels having the equal number of PRBs; and transmitting or receiving sidelink communication in the set of remaining PRBs.

In aspect 26, the method of aspect 25 further includes that the wireless device transmits or receives the sidelink communication in the remaining set of PRBs based on the sidelink communication being unicast.

In aspect 27, the method of aspect 25 or aspect 26 further includes that the wireless device transmits or receives the sidelink communication in the set of remaining PRBs if the sidelink communication is a cast type supports a capability exchange.

In aspect 28, the method of any of aspect 25-27 further includes that transmission or reception of the indication includes an exchange of user equipment (UE) capability information over sidelink, the UE capability information including the indication, wherein the wireless device transmits or receives the sidelink communication in the second set of PRBs based at least in part on exchanging the UE capability information.

In aspect 29, the method of any of aspects 25-28 further includes that the UE capability information indicates support for using the set of remaining PRBs in connection with a number of PRBs in the set of remaining PRBs.

In aspect 30, the method of aspect 29 further includes that the UE capability information includes a plurality of indications of support for using the set of remaining PRBs for different numbers of PRBs in the set of remaining PRBs.

In aspect 31, the method of any of aspects 25-30 further includes that the wireless device transmits or receives the sidelink communication in the set of remaining PRBs further based on using an adjacent sub-channel to the set of remaining PRBs.

In aspect 32, the method of any of aspects 25-31 further includes that the wireless device transmits or receives a physical sidelink control channel (PSCCH) comprising a first portion of sidelink control information (SCI) in the one or more sub-channels having an equal number of PRBs and not in the set of remaining PRBs.

In aspect 33, the method of any of aspects 25-32 further includes that the wireless device transmits or receives at least a portion of a physical sidelink shared channel (PSSCH) in the set of remaining PRBs.

In aspect 34, the method of any of aspects 25-33 further includes that the portion of the PSSCH that is transmitted or received in the set of remaining PRBs comprises at least one of data, a demodulation reference signal, and a phase tracking reference signal (PT-RS).

In aspect 35, the method of any of aspects 25-34 further includes that the PSSCH includes a second portion of the SCI in the one or more sub-channels having an equal number of PRBs and not in the set of remaining PRBs.

In aspect 36, the method of any of aspects 25-34 further includes that the PSSCH includes a second portion of the SCI in the set of remaining PRBs and at least an adjacent sub-channel comprising PRBs from the one or more sub-channels having an equal number of PRBs.

In aspect 37, the method of any of aspects 25-36 further includes that the wireless device transmits or receives a channel state information reference signal (CSI-RS) in the one or more sub-channels having an equal number of PRBs and not in the set of remaining PRBs.

In aspect 38, the method of any of aspects 25-36 further includes that the wireless device transmits or receives at least a portion of a channel state information reference signal (CSI-RS) in the second set of remaining PRBs and at least an adjacent sub-channel comprising PRBs from the one or more sub-channels having an equal number of PRBs.

In aspect 39, the method of any of aspects 25-38 further includes that the wireless device transmits or receives a physical sidelink feedback channel (PSFCH) in the one or more sub-channels having an equal number of PRBs and not in the set of remaining PRBs.

In aspect 40, the method of any of aspects 25-38 further includes that the wireless device transmits or receives at least a portion of a physical sidelink feedback channel (PSFCH) in the set of remaining PRBs and at least an adjacent sub-channel comprising PRBs from the one or more sub-channels having an equal number of PRBs.

In aspect 41, the method of any of aspects 25-40 further includes that the wireless device transmits or receives a sidelink synchronization signal block (SSB) in the one or more sub-channels having an equal number of PRBs and not in the set of remaining PRBs.

In aspect 42, the method of any of aspects 25-41 further includes transmitting a first portion of sidelink control information that indicates whether a transmission will use the set of remaining PRBs.

In aspect 43, the method of any of aspects 25-42 further includes receiving a first portion of sidelink control information that indicates whether a transmission will use the set of remaining PRBs.

In aspect 44, the method of any of aspects 25-43 further includes performing sensing for resource selection based on the one or more sub-channels having an equal number of PRBs without sensing on the set of remaining PRBs.

In aspect 45, the method of any of aspects 25-44 further includes that the wireless device does not perform measurements on reference signals in the set of remaining PRBs.

In aspect 46, the method of any of aspects 25-45 further includes excluding a sub-channel comprising only PRBs in the set of remaining PRBs from a resource selection procedure.

In aspect 47, the method of any of aspects 25-46 further includes determining channel state information for a reference resource based on an allocation size without the set of remaining PRBs.

Aspect 48 is an apparatus for wireless communication at a wireless device, comprising: means for performing the method of any of aspects 1-47.

Aspect 49 is an apparatus for wireless communication, comprising: a memory; and at least one processor coupled to the memory and configured to perform the method of any of aspects 1-47.

Aspect 50 is a non-transitory computer-readable storage medium storing computer executable code for wireless communication, the code when executed by a processor cause the processor to perform the method of any of aspects 1-47.

What is claimed is:

1. An apparatus for wireless communication at a wireless device, comprising:
a memory; and
at least one processor coupled to the memory, the memory and the at least one processor configured to:
transmit or receive an indication of support for using a set of remaining physical resource blocks (PRBs) in a resource pool comprising one or more sub-channels having an equal number of PRBs and the set of remaining PRBs that are not in the one or more sub-channels having the equal number of PRBs; and
transmit or receive sidelink communication in the set of remaining PRBs.

2. The apparatus of claim 1, wherein the memory and the at least one processor are configured to transmit or receive the sidelink communication in the set of remaining PRBs based on the sidelink communication being unicast.

3. The apparatus of claim 1, wherein the memory and the at least one processor are configured to transmit or receive the sidelink communication in the set of remaining PRBs if the sidelink communication is a cast type supports a capability exchange.

4. The apparatus of claim 1, wherein transmission or reception of the indication includes an exchange of user equipment (UE) capability information over sidelink, the UE capability information including the indication, wherein the memory and the at least one processor are configured to transmit or receive the sidelink communication in the set of remaining PRBs based at least in part on exchanging the UE capability information.

5. The apparatus of claim 4, wherein the UE capability information indicates support for using the set of remaining PRBs in connection with a number of PRBs in the set of remaining PRBs.

6. The apparatus of claim 5, wherein the UE capability information includes a plurality of indications of support for using the set of remaining PRBs for different numbers of PRBs in the set of remaining PRBs.

7. The apparatus of claim 1, wherein the memory and the at least one processor are configured to transmit or receive the sidelink communication in the set of remaining PRBs further based on using an adjacent sub-channel to the set of remaining PRBs.

8. The apparatus of claim 1, wherein the memory and the at least one processor are configured to transmit or receive a physical sidelink control channel (PSCCH) comprising a first portion of sidelink control information (SCI) in the one or more sub-channels having the equal number of PRBs and not in the set of remaining PRBs.

9. The apparatus of claim 8, wherein the memory and the at least one processor are configured to transmit or receive at least a portion of a physical sidelink shared channel (PSSCH) in the set of remaining PRBs.

10. The apparatus of claim 9, wherein the portion of the PSSCH that is transmitted or received in the set of remaining PRBs comprises at least one of data, a demodulation reference signal, and a phase tracking reference signal (PT-RS).

11. The apparatus of claim 9, wherein the PSSCH includes a second portion of the SCI in the one or more sub-channels having the equal number of PRBs and not in the set of remaining PRBs.

12. The apparatus of claim 9, wherein the PSSCH includes a second portion of the SCI in the set of remaining PRBs and at least an adjacent sub-channel comprising PRBs from the one or more sub-channels having the equal number of PRBs.

13. The apparatus of claim 1, wherein the memory and the at least one processor are configured to transmit or receive a channel state information reference signal (CSI-RS) in the one or more sub-channels having the equal number of PRBs and not in the set of remaining PRBs.

14. The apparatus of claim 1, wherein the memory and the at least one processor are configured to transmit or receive at least a portion of a channel state information reference signal (CSI-RS) in the set of remaining PRBs and at least an adjacent sub-channel comprising PRBs from the one or more sub-channels having the equal number of PRBs.

15. The apparatus of claim 1, wherein the memory and the at least one processor are configured to transmit or receive a physical sidelink feedback channel (PSFCH) in the one or more sub-channels having the equal number of PRBs and not in the set of remaining PRBs.

16. The apparatus of claim 1, wherein the memory and the at least one processor are configured to transmit or receive at least a portion of a physical sidelink feedback channel (PSFCH) in the set of remaining PRBs and at least an adjacent sub-channel comprising PRBs from the one or more sub-channels having the equal number of PRBs.

17. The apparatus of claim 1, wherein the memory and the at least one processor are configured to transmit or receive a sidelink synchronization signal block (SSB) in the one or more sub-channels having the equal number of PRBs and not in the set of remaining PRBs.

18. The apparatus of claim 1, wherein the memory and the at least one processor are further configured to:
transmit a first portion of sidelink control information that indicates whether a transmission will use the set of remaining PRBs.

19. The apparatus of claim 1, wherein the memory and the at least one processor are further configured to:
receive a first portion of sidelink control information that indicates whether a transmission will use the set of remaining PRBs.

20. The apparatus of claim 1, wherein the memory and the at least one processor are further configured to:
perform sensing for resource selection based on the one or more sub-channels having the equal number of PRBs without sensing on the set of remaining PRBs.

21. The apparatus of claim 20, wherein the memory and the at least one processor are further configured to not perform measurements on reference signals in the set of remaining PRBs.

22. The apparatus of claim 1, wherein the memory and the at least one processor are further configured to:
exclude a sub-channel comprising the set of remaining PRBs and not having having the equal number of PRBs from a resource selection procedure.

23. The apparatus of claim 1, wherein the memory and the at least one processor are further configured to:
determine channel state information for a reference resource based on an allocation size without the set of remaining PRBs.

24. A method of wireless communication at a wireless device, comprising:
transmitting or receiving an indication of support for using a set of remaining physical resource blocks (PRBs) in a resource pool comprising one or more sub-channels having an equal number of PRBs and the set of remaining PRBs that are not in the one or more sub-channels having the equal number of PRBs; and
transmitting or receiving sidelink communication in the set of remaining PRBs.

25. The method of claim 24, wherein the wireless device transmits or receives the sidelink communication in the remaining set of PRBs based on the sidelink communication being unicast.

26. The method of claim 24, wherein transmitting or receiving the indication includes exchanging user equipment (UE) capability information over sidelink, the UE capability information including the indication, wherein the wireless device transmits or receives the sidelink communication in the set of remaining PRBs based at least in part on exchanging the UE capability information.

27. The method of claim 26, wherein the UE capability information indicates support for using the set of remaining PRBs in connection with a number of PRBs in the set of remaining PRBs.

28. The method of claim 24, wherein the wireless device transmits or receives the sidelink communication in the set of remaining PRBs further based on using an adjacent sub-channel to the set of remaining PRBs.

29. An apparatus for wireless communication at a wireless device, comprising:
means for transmitting or receiving an indication of support for using a set of remaining physical resource blocks (PRBs) in a resource pool comprising one or more sub-channels having an equal number of PRBs and the set of remaining PRBs that are not in the one or more sub-channels having the equal number of PRBs; and
means for transmitting or receiving sidelink communication in the set of remaining PRBs.

30. A computer-readable medium storing computer executable code for wireless communication, the code when executed by a processor cause the processor to:
transmit or receive an indication of support for using a set of remaining physical resource blocks (PRBs) in a resource pool comprising one or more sub-channels having an equal number of PRBs and the set of remaining PRBs that are not in the one or more sub-channels having the equal number of PRBs; and
transmit or receive sidelink communication in the set of remaining PRBs.
